(19) United States
(12) Patent Application Publication
(10) Pub. No.: US 2023/0130843 A1
(43) Pub. Date: Apr. 27, 2023

(54) DEEPWATER CABIN-BASED CONSTRUCTED WETLAND TREATMENT SYSTEM

(71) Applicant: Jiangxi Academy of Eco-Environmental Research and Planning, Nanchang (CN)

(72) Inventors: Meng ZHANG, Nanchang (CN); Junwei WU, Nanchang (CN); Min ZHOU, Nanchang (CN); Mingshu LI, Nanchang (CN); Bing FENG, Nanchang (CN); Zugen LIU, Nanchang (CN); Qipei WANG, Nanchang (CN); Na YAO, Nanchang (CN)

(73) Assignee: Jiangxi Academy of Eco-Environmental Research and Planning, Nanchang (CN)

(21) Appl. No.: 17/698,276

(22) Filed: Mar. 18, 2022

(30) Foreign Application Priority Data
Oct. 25, 2021 (CN) 202111240900.X

(51) Int. Cl. C02F 9/00

(52) U.S. Cl. CPC C02F 9/00; C02F 3/327

(57) ABSTRACT

The present disclosure provides a deepwater cabin-based constructed wetland treatment system, including a cabin body, water inlet subsystems, a drainage subsystem, a micro-aeration subsystem, and a filtering scrapper subsystem. The micro-aeration subsystem includes a micro-porous aeration pipe and an air blower. The cabin body is filled with combined filler. The micro-porous aeration pipe is arranged at a bottom of the cabin body. The filtering scrapper subsystem is arranged above the combined filler. The water inlet subsystems are used for introducing wastewater to be purified onto the filtering scrapper subsystem. The filtering scrapper subsystem is used for performing filtering treatment on the wastewater to be purified to obtain filtered impurities and water after primary filtering, transporting the filtered impurities to a specified area, and introducing the water after the primary filtering onto the combined filler.

### CROSS REFERENCE TO RELATED APPLICATION(S)

This patent application claims the benefit and priority of Chinese Patent Application No. 202111240900.X, filed on Oct. 25, 2021, the disclosure of which is incorporated by reference herein in its entirety as part of the present application.

### TECHNICAL FIELD

The present disclosure relates to the technical field of wastewater treatment, and in particular, to a deepwater cabin-based constructed wetland treatment system.

### BACKGROUND ART

At present, eutrophication of a waterbody is a global ecological problem. In view of eutrophication treatment of a large number of shallow lakes and actual needs of lake ecological restoration, it is of great significance to carry out ecological restoration of the shallow lakes and related management of harmful algal bloom, and a brought ecological service function and regained service value will become more important.

At present, the technologies for river and lake ecological restoration mainly include submerged vegetation restoration, plant community mosaic, constructed wetland treatment, artificial floating islands, sediment dredging, harmful algal bloom prevention and control, water purification, cyanobacteria collection and concentration, fish community structure regulation and control, etc. As a mature wastewater treatment technology, a constructed wetland treatment technology is widely used in onshore wastewater treatment and is partly used for water purification of river branches. Due to low construction and operation cost and easiness in maintenance of a project applied by the constructed wetland treatment technology, it is widely valued and comprehensively promoted. Under the background of increasing demand for eutrophic waterbody treatment, it has broad application space in in-situ treatment of rivers and lakes. However, the development of the constructed wetland technology in the treatment of the rivers and lakes is hindered by a river and lake system due to the limitations of factors, such as large fluctuation of water level, environmental sensitivity, an increasing requirement for water quality, and surrounding available land.

### SUMMARY

An objective of the present disclosure is to overcome the shortcomings and deficiencies of the existing in-situ water eutrophication treatment technology, and provide a deepwater cabin-based constructed wetland treatment system, so as to achieve an objective of de-eutrophication of a waterbody on the basis of not occupying a land by the side of a water area to be purified. The scope of application of the present disclosure is ecological interception of pollutants in a eutrophic waterbody and water quality improvement and decentralized wastewater treatment.

To achieve the above-mentioned objective, the present disclosure provides the following solutions.

A deepwater cabin-based constructed wetland treatment system includes a cabin body, water inlet subsystems, drainage subsystems, a micro-aeration subsystem, and a filtering scraper subsystem. The micro-aeration subsystem includes a micro-porous aeration pipe and an air blower connected to the micro-porous aeration pipe. The cabin body is filled with combined filler.

The micro-porous aeration pipe is arranged in the cabin body, and the micro-porous aeration pipe is located among the combined filler and the bottom of the cabin body.

The filtering scraper subsystem is arranged above the combined filler.

The water inlet subsystems are used for introducing wastewater to be purified onto the filtering scraper subsystem.

The filtering scraper subsystem is used for performing filtering treatment on the wastewater to be purified to separate filtered impurities from water after primary filtering, transporting the filtered impurities to a specified area, and introducing the water after the primary filtering onto the combined filler.

The drainage subsystems are used for draining purified water located at the area of the micro-porous aeration pipe out of the cabin body.

During operating, the cabin body is set at a water area to be purified. The water inlet subsystems introduce the wastewater to be purified in the water area to be purified onto the filtering scraper subsystem. After filtering treatment of the filtering scraper subsystem, the water after the primary filtering flows into the combined filler. After secondary filtering of the combined filler, the obtained water after the secondary filtering flows into the area of the micro-porous aeration pipe. The air blower blows air into the micro-porous aeration pipe through the connecting pipe, and the water after the secondary filtering treatment is subjected to purification treatment in a water-air opposite running manner, so as to obtain purified water. The drainage subsystems drain the purified water located at the area of the micro-porous aeration pipe out of the cabin body.

Optionally, each water inlet subsystem includes a submersible pump and a water inlet pipe. The submersible pumps are located on the outer side of the cabin body. One end of the water inlet pipe is connected with the submersible pump, and the other end of the water inlet pipe is connected with the filtering scraper subsystem.

During operating, the wastewater to be purified is pumped from the water area to be purified, and flows into the filtering scraper system through the water inlet pipes.

Optionally, the deepwater cabin-based constructed wetland treatment system further includes an aquatic organism escape subsystem.

The filtering scraper subsystem includes a filtering layer, and a rotating scraper and an animal and algal residue separator arranged on the filtering layer.

The rotating scraper is used for moving the filtered impurities remaining on the filtering layer into the animal and algal residue separator.

The aquatic animal and algal residue separator is used for classifying the filtered impurities to obtain animal organisms and algal organisms, and transporting the animal organisms and algal organisms to the aquatic organism escape subsystem.

The aquatic organism escape subsystem is used for releasing the aquatic animal organisms and storing the algal organisms to a specified area.

Optionally, the deepwater cabin-based constructed wetland treatment system further includes an organic glass frame structure arranged in the cabin body. The organic glass frame structure is used for holding the combined filler.

The combined filler includes waste red brick particles, biomass carbon, biological shale ceramsite, and a molecular sieve porous material in sequence from top to bottom.

Optionally, the drainage subsystems are jet type drainage subsystems, and each drainage subsystem includes a submersible pump, a drainage pipe, and a jet nozzle.

The submersible pump is located in the area of the micro-porous aeration pipe. One end of the drainage pipe is connected with the submersible pump, and the other end of the drainage pipe is connected with the jet nozzle. The jet nozzle is located on the filtering scraper subsystem.

Optionally, the deepwater cabin-based constructed wetland treatment system further includes a water collection and distribution subsystem and a movable plant planting subsystem.

The water collection and distribution subsystem includes a bucket type water collecting tank, and a drip type water distribution hose and a coconut palm fiber palm pad arranged in the bucket type water collecting tank. The movable plant planting subsystem includes nitrogen and phosphorus enriched shrub plants planted in the bucket type water collecting tank.

During operating, the water after primary filtering flows into the bucket type water collecting tank. The water in the bucket type water collecting tank is subjected to adsorption and interception treatment by the nitrogen/phosphorus-accumulated shrub species and then flows into the combined filler.

Optionally, the deepwater cabin-based constructed wetland treatment system further includes a protective cover subsystem arranged on the aquatic organism escape subsystem.

Optionally, the deepwater cabin-based constructed wetland treatment system further includes a solar photovoltaic power generation subsystem and a shipboard wind power generation subsystem that are mounted on an edge area of the cabin body and are located on the outer side of the protective cover subsystem.

According to specific embodiments provided by the present disclosure, the present disclosure discloses the following technical effects.

The present disclosure provides the deepwater cabin-based constructed wetland treatment system. During operating, the cabin body is moved to a water area to be purified without occupying a land beside the waterbody to be purified, which meets the actual demand. The water inlet subsystems introduce the wastewater to be purified in the water area to be purified onto the filtering scraper subsystem. After filtering treatment of the filtering scraper subsystem, the water after the primary filtering flows into the combined filler. After secondary filtering of the combined filler, the obtained water after the secondary filtering flows into the area of the micro-porous aeration pipe. The air blower blows air into the micro-porous aeration pipe through the connecting pipe, and the water after the secondary filtering treatment is subjected to purification treatment in a water-air opposite running manner, so as to obtain purified water. The drainage subsystems drain the purified water located at the area of the micro-porous aeration pipe out of the cabin body, that is, multiple filtration and purification operations are realized through the filtering scraper subsystem, the combined filler, and the micro-aeration subsystem, thereby achieving an objective of de-eutrophication of the waterbody.

### BRIEF DESCRIPTION OF THE DRAWINGS

To describe the technical solutions in the embodiments of the present disclosure or in the prior art more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of a deepwater cabin-based constructed wetland treatment system of the present disclosure.

FIG. 2 is a physical map of the deepwater cabin-based constructed wetland treatment system of the present disclosure.

### DETAILED DESCRIPTION OF THE EMBODIMENTS

Technical solutions in the embodiments of the present disclosure will be clearly and completely described herein below with reference to the drawings in the embodiments of the present disclosure. Apparently, the described embodiments are merely part rather than all of the embodiments of the present disclosure. On the basis of the embodiments of the present disclosure, all other embodiments obtained by those of ordinary skill in the art without creative work fall within the scope of protection of the present disclosure.

A constructed wetland technology is a wastewater treatment technology with a broad application prospect, but there are some problems in popularization and application, which are mainly as follows: first, the hydraulic loading of a wetland is limited, which leads to a large occupied area of the wetland; compared with the conventional wastewater treatment process, the occupied area of the constructed wetland is at least twice as large, so that it is difficult to popularize in places with land shortage or high land price. Second, with the extension of wetland operation time, part nutrients will accumulate gradually; and if the maintenance is improper, it is very easy to produce the phenomena of siltation, obstruction, and blockage, which reduces the hydraulic conductivity and the wetland treatment efficiency, and shortens the operation life. Third, with continuous operation of a wastewater treatment process, the adsorption capacity of matrix will tend to be saturated after several years, which will also affect the treatment effect of the wetland. Fourth, the survival of aquatic plants and microorganisms needs a certain amount of water to maintain, so the constructed wetland is difficult to resist an arid climate. Fifth, some subsurface wetlands with unreasonable designs, construction or maintenance and management will cause surface water accumulation. Sixth, a surface flow wetland has a large water surface, which will cause a large number of mosquitoes and flies to breed and threaten the health of the people around the wetland. Seventh, due to certain anoxic and anaerobic areas in the constructed wetland, some anaerobic reactants (such as H₂S and odor substances) will diffuse into air to cause odor diffusion. Eighth, a relatively low temperature can weaken the activities of various organisms. During low temperature, stagnant or dead plants to the wetland has reduced oxygen release capacity to the wetland or even does not release oxygen, so as to reduce or lose the purification capacity to wastewater. Ninth, there are problems, such as wetland plant diseases and pests, fire, self-growth cycle, related maintenance, restoration, and management. Tenth, the constructed wetland technology has innovative application in other fields, and the like.

As the proposal and development period of the constructed wetland technology is still short, the technical development still cannot meet current social needs. In the application of constructed wetlands, it mainly depends on experience and has a tendency of excessive laissez-faire of natural conditions and ignorance of artificial reinforcement, thus affecting achievable different load treatment effects, such as: there are few studies on optimal combinations and stereoscopic intersection of aquatic plant species suitable for different regional conditions, processes of pre-treatment, post-treatment, distribution, and water collection of the process, scientific allocation of bed base materials, wetland structure type, and alternate flow state characteristics of submerged and surface layers, and design theory and methods thereof, and there is a lack of systematicness and integrity. In addition to heavy nitrogen and phosphorus pollution in a eutrophic waterbody, the problems of low oxygen and harmful algal bloom risk of the waterbody are also prominent. Water aeration is an important means to solve low oxygen underwater. Biological suspended solids such as bloom algae in the waterbody and medium-sized aquatic animals in the waterbody need to be subjected to interception, filtering or differentiated escape protection in the process of in-situ treatment. At present, such a complex, ecological and intelligent purification system has not been seen in the treatment of eutrophication of a waterbody.

In order to promote the treatment of the eutrophication of the waterbody and treat a eutrophication problem or a harmful algal bloom risk problem in still water areas of water ecosystems (lakes, rivers, reservoirs, etc.), the present disclosure introduces a constructed wetland treatment system adopting composite aeration-intelligent interception-vertical flow and a treatment operation method thereof, which is a new in-situ long-time sequence treatment technology and equipment for eutrophic water bodies in rivers and lakes, and application thereof.

In order to make the above-mentioned objective, features, and advantages of the present disclosure more apparent and more comprehensible, the present disclosure is further described in detail below with reference to the drawings and specific implementation manners.

### Embodiment 1

An objective of the present embodiment is to overcome the shortcomings and deficiencies of the existing in-situ waterbody eutrophication treatment technology, provide a novel deepwater cabin-based constructed wetland treatment system adopting composite micro-aeration-efficient interception-vertical flow, and particularly, relate to a new in-situ long-time sequence treatment technology and equipment for eutrophic water bodies in rivers and lakes, and application thereof.

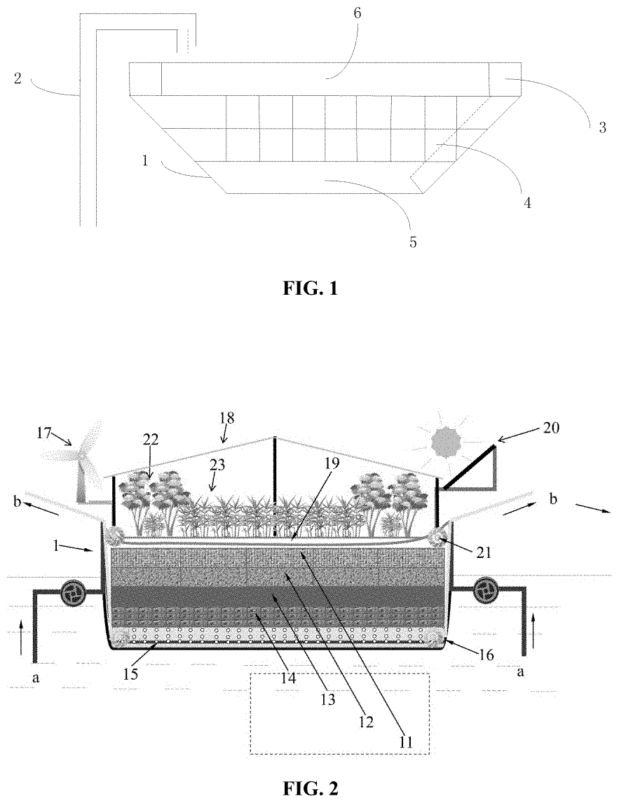

As shown in FIG. 1, the deepwater cabin-based constructed wetland treatment system provided by the present embodiment includes a cabin body 1, water inlet subsystems 2, drainage subsystems 3, a micro-aeration subsystem 5, and a filtering scraper subsystem 6. The micro-aeration subsystem 5 includes a micro-porous aeration pipe and an air blower connected to the micro-porous aeration pipe through a connecting pipe. The cabin body 1 is filled with combined filler 4.

The micro-porous aeration pipe is arranged in the cabin body 1, and the micro-porous aeration pipe is located between the combined filler 4 and a bottom of the cabin body 1.

The filtering scraper subsystem 6 is arranged above the combined filler.

The water inlet subsystems 2 are used for introducing wastewater to be purified onto the filtering scraper subsystem.

The filtering scraper subsystem 6 is used for performing filtering treatment on the wastewater to be purified to obtain filtered impurities and water after primary filtering, transporting the filtered impurities to a specified area, and introducing the water after the primary filtering onto the combined filler.

The drainage subsystems 3 are used for draining purified water located at the area of the micro-porous aeration pipe out of the cabin body.

During operating, the cabin body is moved to a water area to be purified. The water inlet subsystems introduce the wastewater to be purified in the water area to be purified onto the filtering scraper subsystem. After filtering treatment of the filtering scraper subsystem, the water after the primary filtering flows into the combined filler. After secondary filtering of the combined filler, the obtained water after the secondary filtering flows into the area of the micro-porous aeration pipe. The air blower blows air into the micro-porous aeration pipe through the connecting pipe, and the water after the secondary filtering treatment is subjected to purification treatment in a water-air opposite running manner, so as to obtain purified water. The drainage subsystems drain the purified water located at the area of the micro-porous aeration pipe out of the cabin body.

Further, the cabin body of the present embodiment is of a hull body structure with the draught of 0.5 to 3 m, which can be transformed by adopting a decommissioned corrosion-resistant iron transport ship. The size of the cabin body is determined according to the area and the water depth of a treated water area. The cabin body is provided with a power system, a spiral propulsion system, a direction control wheel, an anchoring device, etc.

Further, the water inlet subsystems of the present embodiment are located on both sides out of the cabin body. Each water inlet subsystem includes a submersible pump (the water intake depth is from a surface layer to 6 m) and a water inlet pipe provided with a metering valve. The submersible pumps are located on both sides out of the cabin body. One end of the water inlet pipe is connected with the submersible pump, and the other end of the water inlet pipe is connected with the filtering scraper subsystem.

During operating, the submersible pumps are arranged at both sides out of the cabin body, and are located in the water area to be purified or a lake and reservoir to be purified. Through the operating of the submersible pumps, the wastewater to be purified is pumped from the water area to be purified or the lake and reservoir to be purified, and flows into the filtering scraper system through the water inlet pipes with the metering valves.

Further, the constructed wetland treatment system provided by the present embodiment further includes an aquatic organism escape subsystem. The filtering scraper subsystem includes a filtering layer, and a rotating scraper (with a hairbrush arranged at a front end), an aquatic animal and algal residue separator, and an algae killing tank (with the hydrogen peroxide concentration of 10 to 80 mg/L) arranged on the filtering layer. In a vertical spatial direction, the filtering layer includes a PP cotton filtering screen, 100 to 200-mesh natural cotton filtering screen, and 5 to 20-mesh steel wire screen in sequence from top to bottom.

The rotating scraper is used for moving the filtered impurities remaining on the filtering layer into the aquatic animal and algal residue separator. The aquatic animal and algal residue separator is used for classifying the filtered impurities to obtain both of aquatic animal and algal organisms, and transporting the animal and algal organisms to the aquatic organism escape subsystem. The aquatic organism escape subsystem is used for releasing the animal organisms and storing the algal organisms to a specified area. The aquatic organism escape subsystem includes an escape tank, a one-way trapping cage, and a water grass temporary storage tank.

During operating, the impurities remaining on the filtering layer are transported into the animal and algal residue separator through the rotating scraper, the animal organisms and the algal organisms are separated through the animal and algal residue separator, and then the animal organisms are placed in a water area through the escape tank or temporarily stored through the one-way trapping cage, and the algal organisms are transported to a water grass temporary storage tank. The water grass temporary storage tank is provided with an algae killing tank.

Further, the constructed wetland treatment system provided by the present embodiment further includes an organic glass frame structure arranged in the cabin body. The organic glass frame structure is used for holding the combined filler.

In the vertical spatial direction, the combined filler includes four layers of filler in a modular manner from top to bottom, respectively filler 11—waste red brick particles 2 to 10 mm, filler 12—biomass carbon, filler 13—biological shale ceramsite, and filler 14—a molecular sieve porous material.

A substrate and an interlayer of the organic glass frame structure are made of a coconut fiber material. The organic glass frame structure includes a stainless steel frame and organic glass.

The organic glass frame structure adopts modular components (size: 3 to 5 m long, 1 to 2 m wide, and 2 to 5 m high). Generally, 2 to 8 components are arranged.

During operating, the water after the primary filtering flows to the filler 12 (the biomass carbon), the filler 13 (the biological shale ceramsite), and the filler 14 (the molecular sieve porous material) in sequence from filler 11 (waste red brick particles, Φ2-10 mm). Further, aeration refers to a process of forcibly transferring oxygen in the air to a liquid, which has an objective of obtaining sufficient dissolved oxygen. In addition, aeration also has the purposes of preventing a suspension from sinking and strengthening the contact between organic matters and microorganisms and between the organic matters and the dissolved oxygen, so as to ensure an oxidation and decomposition effect on the organic matters in the wastewater by the microorganisms in the tank under the condition of sufficient dissolved oxygen.

The micro-porous aeration pipe of the present embodiment is a honeycomb ceramic aeration pipe. The honeycomb ceramic aeration pipe is arranged at the bottom of the cabin body. The contact area and probability of the treated waterbody and micro-bubbles are improved in a water-air opposite running manner.

Further, the drainage subsystems of the present embodiment are jet type drainage subsystems. Each drainage subsystem includes a music fountain type jet nozzle, a valve, a submersible pump, and a drainage pipe with a metering valve. The submersible pump is located in the area of the micro-porous aeration pipe. One end of the drainage pipe is communicated with the submersible pump, and the other end of the drainage pipe is communicated with the jet nozzle. The jet nozzle is located on the filtering scraper subsystem.

During operating, the purified water located at the area of the micro-porous aeration pipe is pumped through the submersible pump, and is drained out of the cabin body through the drainage pipe and the music fountain type jet nozzle.

Further, the constructed wetland treatment system provided by the present embodiment further includes a water collection and distribution subsystem and a movable plant planting subsystem.

The water collection and distribution subsystem includes a bucket type water collecting tank, and a drip type water distribution hose and a coconut palm fiber palm pad arranged in the bucket type water collecting tank. The movable plant planting subsystem includes nitrogen and phosphorus enriched shrub plants (Gardenia jasminoides, Lespedeza bicolor, and Senna bicapsularis), herbaceous plants (Solanum lycopersicum, Neyraudia reynaudiana, Phalaris arundinacea, and Cyperus papyrus), and loach and the like aquacultured in the bucket type water collecting tank.

A mosaic combination of enriched shrubs and the herbaceous plants is arranged in the movable plant planting subsystem to perform secondary adsorption interception. Plant planting holes are formed by the plants, such as cattail, according to space gaps stacked in a staggered manner.

During operating, the water after primary filtering flows into the bucket type water collecting tank. The water in the bucket type water collecting tank is subjected to adsorption and interception treatment by the nitrogen and phosphorus-enriched shrub plants and then flows onto the combined filler.

Further, the constructed wetland treatment system provided by the present embodiment further includes a heat insulation cover subsystem arranged on the movable plant planting subsystem. The heat insulation cover subsystem includes a semi-openable tempered glass cover, a steel structure, a stretchable and openable PVC (Polyvinyl Chloride) transparent roller shutter, an exhaust fan, and a lighting assembly.

The constructed wetland treatment system provided by the present embodiment further includes a solar photovoltaic power generation subsystem and a shipboard wind power generation subsystem that are mounted on an edge area of the cabin body and are located on the outer side of the protective cover subsystem.

The solar photovoltaic power generation subsystem includes a solar photovoltaic panel and a photovoltaic power generation controller. The shipboard wind power generation subsystem includes a small-sized wind power generator, a wind power generation controller, a storage battery pack, and connecting wires.

The solar photovoltaic power generation subsystem and the shipboard wind power generation subsystem may complement each other for storing energy, provide power for intermittent or continuous pumping operations, and provide power for a low-frequency air blower.

Further, the constructed wetland treatment system provided by the present embodiment further includes a control system, which is a central control operating system, a microcomputer, a power supply, and control software for a pump, aeration, photovoltaic power generation-energy storage, lighting, music playback-sound, and a nozzle.

FIG. 2 is a physical map of the deepwater cabin-based constructed wetland treatment system of the present disclosure. Waste red brick particles are represented by reference numeral 11, the biomass carbon is represented by reference numeral 12, the biological shale ceramsite is represented by reference numeral 13, the molecular sieve porous material (for example, the honeycomb porous ceramic filler) is represented by reference numeral 14, the micro-porous aeration pipe is represented by reference numeral 15, the submersible pump is represented by reference numeral 16, the cabin body is represented by reference numeral 1 (resin coated plastic steel structure), the wind power generator is represented by reference numeral 17, a retractable transparent cover is represented by reference numeral 18, the movable hollow plant planting plate is represented by reference numeral 19, the solar photovoltaic panel is represented by reference numeral 20, the air blower is represented by reference numeral 21, the nitrogen and phosphorus enriched shrub plants are represented by reference numeral 22, and the nitrogen and phosphorus enriched herbaceous plants are represented by reference numeral 23. Where, a represents inlet water and b indicates spray jet drainage water.

As shown in FIG. 2, the constructed wetland treatment system provided by the present embodiment consists of a composite system arranged in the deepwater cabin body, including water inlet systems, a micro-aeration subsystem, an organic glass modular combined filler, a solar photovoltaic power generation subsystem, a shipboard wind power generation subsystem, a filtering scraper subsystem, an aquatic organism escape subsystem, a water collection and distribution subsystem, a movable plant planting subsystem, a jet type drainage subsystem, a heat insulation cover subsystem, and a control subsystem.

The position and connection relationship thereof are as follows.

In horizontal spatial arrangement, the water inlet systems are located on both sides of the cabin body. The micro-aeration subsystem, the organic glass modular combined filler, the solar photovoltaic power generation subsystem, the shipboard wind power generation subsystem, the filtering scraper subsystem, the aquatic organism escape subsystem, the water collection and distribution subsystem, the movable plant planting subsystem, the jet type drainage subsystem, the heat insulation cover subsystem, and the control subsystem are all arranged in the cabin body. The jet type drainage subsystem, the solar photovoltaic power generation subsystem, and the shipboard wind power generation subsystem are arranged in an edge area of the cabin body or the top of an operation bin of the cabin body. The control system is mainly arranged in the operation bin.

In vertical spatial arrangement, the heat insulation cover subsystem (the solar photovoltaic power generation subsystem and the shipboard wind power generation subsystem being arranged at the same level of the heat insulation cover subsystem and being arranged on the outer side of the heat insulation cover subsystem), the movable plant planting subsystem (part facilities, such as a music fountain type jet nozzle and a valve, of the jet type drainage subsystem being arranged at the same level of the movable plant planting subsystem and being arranged on the outer side of the movable plant planting subsystem), the water collection and distribution subsystem (the water inlet subsystems and part facilitates, such as the air blower, of the micro-aeration subsystem being arranged at the same level of the water collection and distribution subsystem and being arranged on the outer side of the water collection and distribution subsystem), and the micro-aeration subsystem (part facilitates, such as the submersible pump, of the jet type drainage subsystem being arranged at the same level of the micro-aeration subsystem and being arranged on the outer side of the micro-aeration subsystem) are arranged in sequence from top to bottom.

In the connection relationship of various systems, the filtering scraper subsystem is connected behind the water inlet subsystems, and then the water collection and distribution subsystem and the aquatic organism escape subsystem are synchronously arranged; the movable plant planting subsystem is arranged on the bucket type water collection tank in the water collection and distribution subsystem; the aquatic organism escape subsystem is an ecological protection system, and is a branch terminal of the constructed wetland treatment system provided by the present embodiment; the organic glass modular combined filler, the micro-aeration subsystem, and the jet flow type drainage subsystems are connected behind the water collection and distribution sub-system in sequence; and the solar photovoltaic power generation subsystem, the shipboard wind power generation subsystem, the heat insulation cover subsystem, and the control subsystem are power supply, protection, and control facilities, and are support systems for the operation of the constructed wetland treatment system provided by the present embodiment.

Various embodiments in the present specification are described in a progressive manner. Each embodiment focuses on differences from other embodiments, and the same and similar parts of various embodiments may be referred to one another. The system disclosed by the embodiment is described relatively simply since it corresponds to the method disclosed by the embodiment, and reference is made to the description of a method section for relevant points.

In this specification, specific examples are used to describe the principle and implementation manners of the present disclosure. The description of the embodiments above is merely intended to help understand the method and core idea of the present disclosure. In addition, those skilled in the art may make modifications based on the idea of the present disclosure with respect to the specific implementation manners and the application scope. In conclusion, the contents of the present specification shall not be construed as a limitation to the present disclosure.

What is claimed is:

1. A deepwater cabin-based constructed wetland treatment system, comprising a cabin body, water inlet subsystems, a drainage subsystem, a micro-aeration subsystem, and a filtering scraper subsystem, wherein the micro-aeration subsystem comprises a micro-porous aeration pipe and an air blower connected to the micro-porous aeration pipe through a connecting pipe; the cabin body is filled with combined filler;
the micro-porous aeration pipe is arranged in the cabin body, and the micro-porous aeration pipe is located between the combined filler and the bottom of the cabin body;
the filtering scraper subsystem is arranged above the combined filler;
the water inlet subsystem is used for introducing wastewater to be purified onto the filtering scraper subsystem;
the filtering scraper subsystem is used for performing filtering treatment on the wastewater to be purified to obtain filtered impurities and water after primary filtering, transporting the filtered impurities to a specified area, and introducing the water after the primary filtering onto the combined filler;
the drainage subsystems are used for draining purified water located at the area of the micro-porous aeration pipe out of the cabin body;
during operating, the cabin body is moved to a water area to be purified; the water inlet subsystems introduce the wastewater to be purified in the water area to be purified onto the filtering scraper subsystem; after filtering treatment of the filtering scraper subsystem, the water after the primary filtering flows into the combined filler; after secondary filtering of the combined filler, the obtained water after the secondary filtering flows into the area of the micro-porous aeration pipe; the air blower blows air into the micro-porous aeration pipe through the connecting pipe, and the water after the secondary filtering treatment is subjected to purification treatment in a water-air opposite running manner, so as to obtain purified water; and the drainage subsystems drain the purified water located at the area of the micro-porous aeration pipe out of the cabin body.

2. The deepwater cabin-based constructed wetland treatment system according to claim 1, wherein each water inlet system comprises a submersible pump and a water inlet pipe; the submersible pumps are located on the outer side of the cabin body; one end of the water inlet pipe is communicated with the submersible pump, and the other end of the water inlet pipe is communicated with the filtering scraper subsystem; and
during operating, the wastewater to be purified is pumped from the water area to be purified, and flows into the filtering scraper system through the water inlet pipes.

3. The deepwater cabin-based constructed wetland treatment system according to claim 1, further comprising: an aquatic organism escape subsystem, wherein
the filtering scraper subsystem comprises a filtering layer, and a rotating scraper, and an animal and algal residue separator arranged on the filtering layer;
the rotating scraper is used for moving the filtered impurities remaining on the filtering layer into the animal and algal residue separator;
the animal and algal residue separator is used for classifying the filtered impurities to obtain animal organisms and algal organisms, and transporting the animal organisms and algal organisms to the aquatic organism escape subsystem; and
the aquatic organism escape subsystem is used for releasing the animal organisms and storing the algal organisms to a specified area.

4. The deepwater cabin-based constructed wetland treatment system according to claim 1, further comprising an organic glass frame structure arranged in the cabin body, wherein the organic glass frame structure is used for holding the combined filler; and
the combined filler comprises waste red brick particles, biomass carbon, biological shale ceramsite, and a molecular sieve porous material in sequence from top to bottom.

5. The deepwater cabin-based constructed wetland treatment system according to claim 1, wherein the drainage subsystems are jet type drainage subsystems, and each drainage subsystem comprises a submersible pump, a drainage pipe, and a jet nozzle;
the submersible pump is located in the area of the micro-porous aeration pipe; one end of the drainage pipe is communicated with the submersible pump, and the other end of the drainage pipe is communicated with the jet nozzle; and the jet nozzle is located on the filtering scraper subsystem.

6. The deepwater cabin-based constructed wetland treatment system according to claim 1, further comprising a water collection and distribution subsystem and a movable plant planting subsystem, wherein
the water collection and distribution subsystem comprises a bucket type water collecting tank, and a drip type water distribution hose and a coconut palm fiber palm pad arranged in the bucket type water collecting tank; the movable plant planting subsystem comprises nitrogen and phosphorus enriched shrub plants planted in the bucket type water collecting tank;
during operating, the water after primary filtering flows into the bucket type water collecting tank; and the water in the bucket type water collecting tank is subjected to adsorption and interception treatment by the nitrogen and phosphorus-enriched shrub plants and then flows onto the combined filler.

7. The deepwater cabin-based constructed wetland treatment system according to claim 6, further comprising a protective cover subsystem arranged on the aquatic organism escape subsystem.

8. The deepwater cabin-based constructed wetland treatment system according to claim 7, further comprising a solar photovoltaic power generation subsystem and a shipboard wind power generation subsystem that are mounted on an edge area of the cabin body and are located on the outer side of the protective cover subsystem.
